(19) United States
(12) Patent Application Publication
(10) Pub. No.: US 2013/0177438 A1
(43) Pub. Date: Jul. 11, 2013

(54) SECTIONED ROTOR, A STEAM TURBINE HAVING A SECTIONED ROTOR AND A METHOD FOR PRODUCING A SECTIONED ROTOR

(71) Applicants: Thomas Joseph FARINEAU, Schoharie, NY (US); Robin Carl SCHWANT, Pattersonville, NY (US); Nathaniel C. GLINBIZZI, Schenectady, NY (US)

(72) Inventors: Thomas Joseph FARINEAU, Schoharie, NY (US); Robin Carl SCHWANT, Pattersonville, NY (US); Nathaniel C. GLINBIZZI, Schenectady, NY (US)

(73) Assignee: GENERAL ELECTRIC COMPANY, Schenectady, NY (US)

(21) Appl. No.: 13/344,688

(22) Filed: Jan. 6, 2012

(51) Int. Cl. F01D 5/14; B23P 15/00

(52) U.S. Cl. 416/241 R; 29/889.21

(57) ABSTRACT

A sectioned rotor is disclosed that includes a high temperature section. The high temperature section includes a first high temperature material section, a second high temperature material section; and a sectioned high temperature material section formed of a plurality of high temperature material subsection components. The sectioned high temperature material section is joined to the first high temperature material section and the second high temperature section. The plurality of the high temperature subsection components are independently formed of a nickel-based superalloy. A steam turbine having a sectioned rotor and a method for manufacturing a sectioned rotor are also disclosed.

### FIELD OF THE INVENTION

The present invention is generally directed to steam turbines, and more specifically directed to a steam turbine having a sectioned rotor shaft for exposure to supercritical steam.

### BACKGROUND OF THE INVENTION

A typical steam turbine plant may be equipped with a high pressure steam turbine, an intermediate pressure steam turbine and a low pressure steam turbine. Each steam turbine is formed of materials appropriate to withstand operating conditions, pressure, temperature, flow rate, etc., for that particular turbine.

Recently, steam turbine plant designs directed toward a larger capacity and a higher efficiency have been designed that include steam turbines that operate over a range of pressures and temperatures. The designs have included high-low pressure integrated, high-intermediate-low pressure integrated, and intermediate-low pressure integrated steam turbine rotors integrated into one piece and using the same metal material for each steam turbine. Often, a metal is used that is capable of performing in the highest of operating conditions for that turbine, thereby increasing the overall cost of the turbine.

A steam turbine conventionally includes a rotor and a casing jacket. The rotor includes a rotatably mounted turbine shaft that includes blades. When heated and pressurized steam flows through the flow space between the casing jacket and the rotor, the turbine shaft is set in rotation as energy is transferred from the steam to the rotor. The rotor, and in particular the rotor shaft, often forms the bulk of the metal of the turbine. Thus, the metal that forms the rotor significantly contributes to the cost of the turbine. If the rotor is formed of a high cost, high temperature metal, the cost is even further increased. When manufacturing components of high temperature material, such as turbine rotors, forming large single-piece components results in expensive components, extended manufacturing time and such manufacturing capacity is often limited.

Accordingly, it would be desirable to provide a steam turbine rotor formed of smaller forgings than known in the art, having material that is less expensive on a per pound basis than a single forging and has greater ease of manufacture than known in the art for single-component rotor forgings.

### SUMMARY OF THE INVENTION

According to an exemplary embodiment of the present disclosure, a sectioned rotor is disclosed that includes a high temperature section. The high temperature section includes a first high temperature material section, a second high temperature material section; and a sectioned high temperature material section formed of a plurality of high temperature material subsection components. The sectioned high temperature material section is joined to the first high temperature material section and the second high temperature section. The plurality of the high temperature subsection components are independently formed of a nickel-based superalloy.

According to another exemplary embodiment of the present disclosure, a steam turbine is disclosed that includes a sectioned rotor. The sectioned rotor includes a high temperature section. The high temperature section includes a first high temperature material section, a second high temperature material section; and a sectioned high temperature material section formed of a plurality of high temperature material subsection components. The sectioned high temperature material section is joined to the first high temperature material section and the second high temperature section. The plurality of the high temperature subsection components are independently formed of a nickel-based superalloy.

According to another exemplary embodiment of the present disclosure, a method of manufacturing a rotor is disclosed that includes providing a first high temperature material section, a second high temperature material section and plurality of high temperature material subsection components. The plurality of high temperature material subsection components are fastened together to form a sectioned high temperature material section. The first high temperature material section, the second high temperature material section, and the sectioned high temperature material section are joined together to form a high pressure rotor section. The plurality of the high temperature subsection components are independently formed of a nickel based superalloy.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 is a sectional view of a steam turbine according to the present disclosure.

FIG. 2 is a sectional view of a portion of FIG. 1.

Wherever possible, the same reference numbers will be used throughout the drawings to represent the same parts.

### DETAILED DESCRIPTION OF THE INVENTION

The present disclosure now will be described more fully hereinafter with reference to the accompanying drawings, in which an exemplary embodiment of the disclosure is shown. This disclosure may, however, be embodied in many different forms and should not be construed as limited to the embodiments set forth herein.

Provided is a sectioned steam turbine rotor formed of smaller forgings of high temperature material than known in the art, having material that is less expensive on a per pound basis than a single forging. The sectioned rotor arrangement having the high temperature material enables the use of high temperature material in larger, sectioned components, enabling higher inlet temperatures than small unitary component forged components. In addition, the smaller forgings have a greater ease of manufacture than known in the art for single-component rotor forgings. In addition, the smaller forgings may have shorter delivery cycles and enable more efficient manufacturing. In some embodiments, the sectioned rotor includes components that can be disassembled for maintenance and/or repair. In addition, the sectioned rotor permits a variable or tailored material makeup of the rotor that closely corresponds to the rotor conditions without complicated forging or manufacturing techniques.

In embodiments of the present disclosure, the system configuration provides a lower cost steam turbine rotor. Another advantage of an embodiment of the present disclosure includes reduced manufacturing time as the lead time for procuring a multi-component rotor is less than that of a rotor forged from a single-piece forging. Another advantage is that the system provides a means to produce a very large rotor that could not be produced as a single high temperature piece. Embodiments of the present disclosure allow the fabrication of the turbine rotor from a series of smaller forgings made from the same material that are either a) less expensive on a per pound basis than a single forging or b) offer a time savings in terms of procurement cycle vs. a single larger one-piece forging. Such arrangements provide less expensive manufacturing.

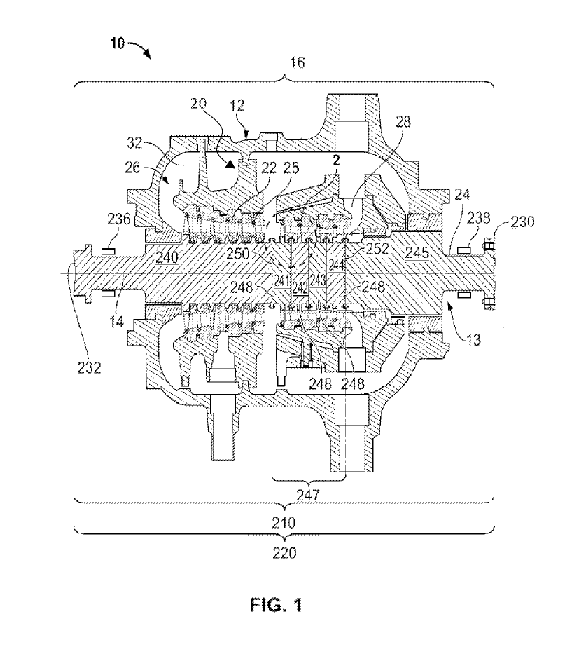

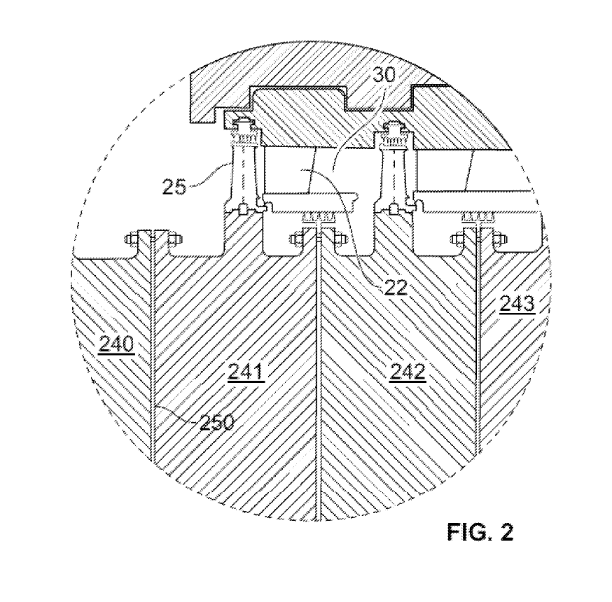

FIGS. 1 and 2 illustrate a sectional diagram of a steam turbine 10 according to an embodiment of the disclosure. FIG. 2 illustrates expanded views of area 2, as indicated on the sectional diagram of FIG. 1. The steam turbine 10 includes a casing 12 in which a turbine rotor 13 is mounted rotatably about an axis of rotation 14. The steam turbine 10 includes a high temperature section including a high pressure (HP) section 16.

In one embodiment, the high temperature section is an HP section 16 operating at super-critical conditions. In one embodiment, the HP section 16 of steam turbine 10 receives steam at a pressure above about 220 bar. In another embodiment, the high pressure section 16 receives steam at a pressure between about 220 bar and about 340 bar. In another embodiment, the high pressure section 16 receives steam at a pressure between about 220 bar to about 240 bar. Additionally, the high pressure section 16 receives steam at a temperature between about 590° C. and about 650° C. In another embodiment, the high pressure section 16 receives steam at a temperature between about 590° C. and about 625° C. In still another embodiment, the high pressure section 16 receives steam at a temperature between about 590° C. and about 760° C. In still another embodiment, the high pressure section 16 receives steam at a temperature between about 590° C. and about 800° C.

In another embodiment, the steam turbine 10 includes a high temperature section wherein the section is an intermediate pressure (IP) section downstream of a similarly configured HP section. The temperature range for the IP section is substantially identical to the temperature range of the HP section (e.g., about 590° C. to about 800° C.), but with lower pressure. For example, pressures for the IP section may be from about 30 bar to about 100 bar.

The casing 12 includes an HP casing 12. In the exemplary embodiment shown in FIG. 1, the HP casing 12 is a double wall casing. The casing 12 includes a housing 20 and a plurality of guide vanes 22 attached to the inner casing 20. The rotor 13 includes a shaft 24 and a plurality of blades 25 fixed to the shaft 24. The shaft 24 is rotatably supported by a first bearing 236 and a second bearing 238.

A main steam flow path 26 is defined as the path for steam flow between the casing 12 and the rotor 13. The main steam flow path 26 includes an HP main steam flow path 30 located in the turbine HP section 16. As used herein, the term “main steam flow path” means the primary flow path of steam that produces power.

Steam is provided to an inflow region 28 of the main steam flow path 26. The steam flows through the HP main steam flow path 30 of the main steam flow path 26 between vanes 22 and blades 25, during which the steam expands and cools. Thermal energy of the steam is converted into mechanical, rotational energy as the steam rotates the rotor 13 about the axis 14. After flowing through the HP main steam flow path section 30, the steam flows out of an steam outflow region 32 into an intermediate superheater (not shown), where the steam is heated to a higher temperature. The steam may be used in other operations, not illustrated in any more detail.

As can further be seen in FIG. 1, the rotor 13 includes a rotor HP section 210 located in the turbine HP section 16. The rotor 13 includes a shaft 24. Correspondingly, the shaft 24 includes a shaft HP section 220 located in the turbine HP section 16. The shaft HP section 220 can be joined, for example, at a bolted joint 230 to other components such as an IP section or other suitable turbine component. In another embodiment, the shaft HP section 220 can be joined to other components by welding, bolting, or other joining technique.

The shaft HP section 220 may be joined to another component (not shown) at the first end 232 of the shaft 24 by a bolted joint, a weld, or other joining technique. In another embodiment, the shaft HP section 220 may be bolted to a generator at the first end 232 of shaft 24.

The shaft HP section 220 receives steam via the inflow region 28 at a pressure above 220 bar. In another embodiment, the shaft HP section 220 may receive steam at a pressure between about 220 bar and about 340 bar. In another embodiment, the shaft HP section 220 may receive steam at a pressure between about 220 bar to about 240 bar. The shaft HP section 220 receives steam at a temperature of between about 575° C. and about 650° C. In another embodiment, the shaft HP section 220 may receive steam at a temperature between about 590° C. and about 625° C. In still another embodiment, the shaft HP section 220 may receive steam at a temperature between about 590° C. and about 760° C. In still another embodiment, the shaft HP section 220 may receive steam at a temperature between about 590° C. and about 800° C.

The shaft HP section 220 includes a first high temperature material (HTM) section 240, a sectioned HTM section 247, and a second HTM section 245. The sectioned HTM section 247 is made up of a plurality of HTM subsection components 248. As shown in FIG. 1, the sectioned HTM section 247 includes a first subsection 241, a second subsection 242, a third subsection 243 and a fourth subsection 244, which are fastened together by bolts or other suitable fasteners. In an embodiment, the HTM subsection components 248 are joined by welding. While FIG. 1 shows four HTM subsection components 248, more or less HTM subsection components 248 may be utilized. In addition, while FIG. 1 shows HTM subsection components 248 of substantially uniform thickness, the individual HTM subsection components 248 may vary in thickness and geometry. The sectioned HTM section 247 and HTM subsection components 248 permit the fabrication of smaller forgings or fabricated components from high temperature material. While the above arrangement of subsections for the shaft HP section 220 has been described with respect to the turbine HP section 16, the sectioning with subsections of an turbine IP section could likewise be provided with a similar arrangement of subsections.

The shaft HP section 220 is rotatably supported by a first bearing 236 (FIG. 1) and a second bearing 238 (FIG. 1). In an embodiment, the first bearing 236 may be a journal bearing. In an embodiment, the second bearing 238 may be a thrust/journal bearing. In another embodiment, different support bearing configurations may be used. The first bearing 236 supports the first HTM section 240, and the second bearing 238 supports the third HTM section 245. In an embodiment where the HTM section 242 extends to the bolted joint 230, the second bearing 238 supports the HTM section 242. In another embodiment, different support bearing configurations may be used.

The first and second HTM sections 240, 245 are joined to the sectioned HTM section 247 at HP first joint 250 and HP second joint 252. As shown in FIG. 1, HP first joint 250 and HP second joint 252 are bolted joints. However, in another embodiment, joined by other suitable fasteners or by a welded joint. Each of the HTM sections 240 and 245 may include one or more HTM sections joined together, for example by a bolted joint, a weld, or other joining technique. In an embodiment, the first and second HTM sections 240, 245 are formed of single, unitary sections or blocks of high temperature resistant material. The high temperature resistant material may be referred to as a high temperature material. In another embodiment, the HTM sections 240, 245 may be formed of one or more HTM sections or blocks of high temperature material that are joined together by a material joining technique, such as, but not limited to, welding and bolting.

The sectioned HTM section 247 at least partially defines the inflow region 28 and HP main steam flow path 30 (FIG. 2). The first HTM section 240 further at least partially defines the HP main steam flow path 30. In another embodiment, the HP first joint 250 may be moved so that the first HTM section 240 does not at least partially define the HP main steam flow path 30 and the sectioned HTM section 247 makes up a majority or all of the main steam flow path 30 exposure to rotor 13 in the HP section 220 of the turbine. The second HTM section 245 does not at least partially define the main steam flow path 26, or in other words, the second HTM section 245 is outside of the HP main steam flow path 30 and does not contact the main steam flow path 26.

The high temperature material is a nickel-based superalloy. In an embodiment, the high temperature material may be a nickel-based superalloy including an amount of chromium (Cr), molybdenum (Mo), columbium (Cb) and nickel (Ni) as remainder. In an embodiment, the high temperature material may be a nickel-based superalloy including 16-25 wt % of Cr, up to 15 wt % of Co, 4-12 wt % of Mo, up to 6 wt % of Cb, 0.3-4.0 wt % of Ti, 0.05-3.0 wt % of Al, up to 0.04 wt % of B, up to 10 wt % of Fe and balance Ni and incidental impurities.

In another embodiment the high temperature material may be a nickel-based superalloy including 16-25 wt % of Cr, 4-12 wt % of Mo, 1.0-6.0 wt % of Cb, 0.3-4.0 wt % of Ti, 0.05-1.0 wt % of Al, up to 10 wt % of Fe, and balance Ni and incidental impurities. In another embodiment, the nickel-based superalloy includes 18-23 wt % of Cr, 6-9 wt % of Mo, 2.0-5.0 wt % of Cb, 0.6-3.0 wt % of Ti, 0.05-0.5 wt % of Al, 2-7 wt % of Fe, and balance Ni and incidental impurities. In still another embodiment, the nickel-based superalloy includes 19-22 wt % of Cr, 6.5-8.0 wt % of Mo, 3.0-4.5 wt % of Cb, 1.0-2.0 wt % of Ti, 0.1-0.3 wt % of Al, 3.0-5.5 wt % of Fe, and balance Ni and incidental impurities.

In another embodiment the high temperature material may be a nickel-based superalloy including 16-24 wt % of Cr, 5-15 wt % of Co, 5-12 wt % of Mo, 0.5-4.0 wt % of Ti, 0.3-3.0 wt % of Al, 0.002-0.04 wt % of B, and balance Ni and incidental impurities. In another embodiment, the nickel-based superalloy includes 18-22 wt % of Cr, 8-12 wt % of Co, 6-10 wt % of Mo, 1.0-3.0 wt % of Ti, 0.8-2.0 wt % of Al, 0.002-0.02 wt % of B, and balance Ni and incidental impurities. In still another embodiment, the nickel-based superalloy includes 19-21 wt % of Cr, 9-11 wt % of Co, 7-9 wt % of Mo, 1.7-2.5 wt % of Ti, 1.2-1.8 wt % of Al, 0.002-0.01 wt % of B, and balance Ni and incidental impurities.

The first and second HTM sections 240, 245 may be formed of the same HTM. In another embodiment, the first, second and third HTM sections may be formed of different HTM.

In another embodiment, one or both of the first and second HTM sections 240 and 245 may independently be formed of an iron-based HTM. For example, the high temperature material may be a forging steel. In an embodiment, the forging steel may be a high-chromium alloy steel. In another embodiment, the high temperature material may be a steel including an amount of chromium (Cr), molybdenum (Mo), vanadium (V), manganese (Mn), and cobalt (Co). In an embodiment, the high temperature material may be a high-chromium alloy steel including 0.1-1.2 wt % of Mn, up to 1.5 wt % of Ni, 8.0-15.0 wt % of Cr, up to 4.0 wt % of Co, 0.5-3.0 wt % of Mo, 0.05-1.0 wt % of V, 0.02-0.5 wt % of Cb, 0.005-0.15 wt % of N, up to 0.04 wt % of B, up to 3.0 wt % of W, and balance Fe and incidental impurities.

In another embodiment the high temperature material may be a high-chromium alloy steel including 0.2-1.2 wt % of Mn, 9.0-13.0 wt % of Cr, 0.5-3.0 wt % of Mo, 0.05-1.0 wt % of V, 0.02-0.5 wt % of Cb, 0.02-0.15 wt % of N, and balance Fe and incidental impurities. In another embodiment, the high-chromium alloy includes 0.3-1.0 wt % of Mn, 10.0-11.5 wt % of Cr, 0.7-2.0 wt % of Mo, 0.05-0.5 wt % of V, 0.02-0.3 wt % of Cb, 0.02-0.10 wt % of N, and balance Fe and incidental impurities. In still another embodiment, the high-chromium alloy includes 0.4-0.9 wt % of Mn, 10.4-11.3 wt % of Cr, 0.8-1.2 wt % of Mo, 0.1-0.3 wt % of V, 0.04-0.15 wt % of Cb, 0.03-0.09 wt % of N, and balance Fe and incidental impurities.

In another embodiment the high temperature material may be a high-chromium alloy steel including 0.2-1.2 wt % of Mn, 0.2-1.5 wt % of Ni, 8.0-15.0 wt % of Cr, 0.5-3.0 wt % of Mo, 0.05-1.0 wt % of V, 0.02-0.5 wt % of Cb, 0.02-0.15 wt % of N, 0.2-3.0 wt % of W, and balance Fe and incidental impurities. In another embodiment, the high-chromium alloy includes 0.2-0.8 wt % of Mn, 0.4-1.0 wt % of Ni, 9.0-12.0 wt % of Cr, 0.7-1.5 wt % of Mo, 0.05-0.5 wt % of V, 0.02-0.3 wt % of Cb, 0.02-0.10 wt % of N, 0.5-2.0 wt % of W, and balance Fe and incidental impurities. In still another embodiment, the high-chromium alloy includes 0.3-0.7 wt % of Mn, 0.5-0.9 wt % of Ni, 9.9-10.7 wt % of Cr, 0.9-1.3 wt % of Mo, 0.1-0.3 wt % of V, 0.03-0.08 wt % of Cb, 0.03-0.09 wt % of N, 0.9-1.2 wt % of W, and balance Fe and incidental impurities.

In another embodiment the high temperature material may be a high-chromium alloy steel including 0.1-1.2 wt % of Mn, 0.05-1.00 wt % of Ni, 7.0-11.0 wt % of Cr, 0.5-4.0 wt % of Co, 0.5-3.0 wt % of Mo, 0.1-1.0 wt % of V, 0.02-0.5 wt % of Cb, 0.005-0.06 wt % of N, 0.002-0.04 wt % of B, and balance Fe and incidental impurities. In another embodiment, the high-chromium alloy includes 0.1-0.8 wt % of Mn, 0.08-0.4 wt % of Ni, 8.0-10.0 wt % of Cr, 0.8-2.0 wt % of Co, 1.0-2.0 wt % of Mo, 0.1-0.5 wt % of V, 0.02-0.3 wt % of Cb, 0.01-0.04 wt % of N, 0.005-0.02 wt % of B, and balance Fe and incidental impurities. In still another embodiment, the high-chromium alloy includes 0.2-0.5 wt % of Mn, 0.08-0.25 wt % of Ni, 8.9-937 wt % of Cr, 1.1-1.5 wt % of Co, 1.3-1.7 wt % of Mo, 0.15-0.3 wt % of V, 0.04-0.07 wt % of Cb, 0.014-0.032 wt % of N, 0.007-0.014 wt % of B, and balance Fe and incidental impurities.

The shaft 24 may be produced by an embodiment of a method of manufacturing as described below. The shaft HP section 220 may be produced by joining HTM section 240 to sectioned HTM section 247 and joining sectioned HTM section 247 to HTM section 245.

While only certain features and embodiments of the invention have been shown and described, many modifications and changes may occur to those skilled in the art (for example, variations in sizes, dimensions, structures, shapes and proportions of the various elements, values of parameters (for example, temperatures, pressures, etc.), mounting arrangements, use of materials, orientations, etc.) without materially departing from the novel teachings and advantages of the subject matter recited in the claims. The order or sequence of any process or method steps may be varied or re-sequenced according to alternative embodiments. It is, therefore, to be understood that the appended claims are intended to cover all such modifications and changes as fall within the true spirit of the invention. Furthermore, in an effort to provide a concise description of the exemplary embodiments, all features of an actual implementation may not have been described (i.e., those unrelated to the presently contemplated best mode of carrying out the invention, or those unrelated to enabling the claimed invention). It should be appreciated that in the development of any such actual implementation, as in any engineering or design project, numerous implementation specific decisions may be made. Such a development effort might be complex and time consuming, but would nevertheless be a routine undertaking of design, fabrication, and manufacture for those of ordinary skill having the benefit of this disclosure, without undue experimentation.

1. A sectioned rotor, comprising:
a high temperature section comprising:
a first high temperature material section;
a second high temperature material section; and
a sectioned high temperature material section formed of a plurality of high temperature material subsection components, the sectioned high temperature material section being joined to the first high temperature material section and the second high temperature section; and
wherein the plurality of the high temperature subsection components are independently formed of a nickel-based superalloy.

2. The sectioned rotor of claim 1, wherein the plurality of high temperature material subsection components are joined together by bolting.

3. The sectioned rotor of claim 1, wherein the plurality of high temperature material subsection components are formed of substantially identical compositions.

4. The sectioned rotor of claim 1, wherein the plurality of high temperature material subsection components are formed of differing compositions.

5. The sectioned rotor of claim 1, wherein the nickel-based superalloy comprises 16-25 wt % of Cr, 4-12 wt % of Mo, 1.0-6.0 wt % of Cb, 0.3-4.0 wt % of Ti, 0.05-1.0 wt % of Al, up to 10 wt % of Fe, and balance Ni and incidental impurities.

6. The sectioned rotor of claim 1, wherein the nickel-based superalloy comprises 16-24 wt % of Cr, 5-15 wt % of Co, 5-12 wt % of Mo, 0.5-4.0 wt % of Ti, 0.3-3.0 wt % of Al, 0.002-0.04 wt % of B, and balance Ni and incidental impurities.

7. The sectioned rotor of claim 1, wherein one or both of the first high temperature material section and the second high temperature material section is a high-chromium steel.

8. The sectioned rotor of claim 7, wherein the high-chromium steel comprises 0.1-1.2 wt % of Mn, up to 1.5 wt % of Ni, 8.0-15.0 wt % of Cr, up to 4.0 wt % of Co, 0.5-3.0 wt % of Mo, 0.05-1.0 wt % of V, 0.02-0.5 wt % of Cb, 0.005-0.15 wt % of N, up to 0.04 wt % of B, up to 3.0 wt % of W, and balance Fe and incidental impurities.

9. A steam turbine, comprising:
a sectioned rotor comprising:
a first high temperature material section;
a second high temperature material section; and
a sectioned high temperature material section formed of a plurality of high temperature material subsection components, the sectioned high temperature material section being joined to the first high temperature material section and the second high temperature section;
wherein the plurality of the high temperature subsection components are independently formed of a nickel-based superalloy.

10. The steam turbine of claim 9, wherein the plurality of high temperature material subsection components are joined together by bolting.

11. The steam turbine of claim 9, wherein the plurality of high temperature material subsection components are formed of substantially identical compositions.

12. The steam turbine of claim 9, wherein the plurality of high temperature material subsection components are formed of differing compositions.

13. The steam turbine of claim 9, wherein the nickel-based superalloy comprises 16-25 wt % of Cr, 4-12 wt % of Mo, 1.0-6.0 wt % of Cb, 0.3-4.0 wt % of Ti, 0.05-1.0 wt % of Al, up to 10 wt % of Fe, and balance Ni and incidental impurities.

14. The steam turbine of claim 9, wherein the nickel-base superalloy comprises 16-24 wt % of Cr, 5-15 wt % of Co, 5-12 wt % of Mo, 0.5-4.0 wt % of Ti, 0.3-3.0 wt % of Al, 0.002-0.04 wt % of B, and balance Ni and incidental impurities.

15. The steam turbine of claim 9, wherein one or both of the first high temperature material section and the second high temperature material section is a high-chromium steel.

16. The steam turbine of claim 15, wherein the high-chromium steel comprises 0.1-1.2 wt % of Mn, up to 1.5 wt % of Ni, 8.0-15.0 wt % of Cr, up to 4.0 wt % of Co, 0.5-3.0 wt % of Mo, 0.05-1.0 wt % of V, 0.02-0.5 wt % of Cb, 0.005-0.15 wt % of N, up to 0.04 wt % of B, up to 3.0 wt % of W, and balance Fe and incidental impurities.

17. A method of manufacturing a sectioned rotor, comprising:
providing a first high temperature material section, a second high temperature material section, and a plurality of high temperature subsection components; and
fastening the plurality of high temperature material subsection components together to form a sectioned high temperature material section;
joining the first high temperature material section, the second high temperature material section, and the sectioned high temperature material section to form a high pressure rotor section;
wherein the plurality of the high temperature subsection components are independently formed of a nickel-based superalloy.

18. The method of claim 17, wherein the nickel-based superalloy comprises 16-25 wt % of Cr, 4-12 wt % of Mo, 1.0-6.0 wt % of Cb, 0.3-4.0 wt % of Ti, 0.05-1.0 wt % of Al, up to 10 wt % of Fe, and balance Ni and incidental impurities.

19. The method of claim 17, wherein the nickel-based superalloy comprises 16-24 wt % of Cr, 5-15 wt % of Co, 5-12 wt % of Mo, 0.5-4.0 wt % of Ti, 0.3-3.0 wt % of Al, 0.002-0.04 wt % of B, and balance Ni and incidental impurities.

20. The method of claim 17, wherein one or both of the first high temperature material section and the second high temperature material section is a high-chromium steel.
